(19) United States
(12) Patent Application Publication
(10) Pub. No.: US 2010/0280959 A1
(43) Pub. Date: Nov. 4, 2010

(54) REAL-TIME SOURCING OF SERVICE PROVIDERS

(76) Inventors: Darrel Stone, Polson, MT (US); Brandon Smith, Ronan, MT (US); Doug Odegaard, Missoula, MT (US); Rod Haynes, Missoula, MT (US)

Correspondence Address: BOSWELL IP Law, 601 Union Street, SUITE 4200, SEATTLE, WA, 98101-4036, US

(21) Appl. No.: 12/434,554

(22) Filed: May 1, 2009

(51) Int. Cl. G06Q 30/00; G06Q 10/00; G06F 3/048; G06Q 20/00

(52) U.S. Cl. 705/80; 705/9; 705/10; 705/26; 715/780; 705/14.44

(57) ABSTRACT

A real-time sourcing system is described herein that matches consumers with service requests to providers that perform the requested services. In addition, the system automates communication between consumers and providers. The real-time sourcing system provides automated and integrated end-to-end management of a transaction. The system receives a request from a consumer that describes a particular service needed by the consumer, and sends notifications to registered providers based on the requested service. The system receives an offer from one or more notified providers that indicates terms under which the provider would perform the requested service, and sends offers that match the consumer's criteria to the consumer for evaluation. The system receives an acceptance of an offer from the consumer. Thus, the real-time sourcing system reduces the time involved with finding providers to perform services, and provides consumers with more relevant selections of providers to perform services.

### BACKGROUND

Consumers locate service providers to perform numerous tasks every day. For example, a consumer with a leaky faucet may locate a plumber to fix the leak. Traditionally, consumers locate service providers using print directories, such as the Yellow Pages, or more recently using online directories, such as Yahoo or Google search engines. Directories are often divided by category to facilitate locating a provider that performs the appropriate type of work.

After a consumer has located one or more providers, the consumer often engages in a negotiation process that involves determining whether the provider is willing to do the work and if so the terms under which the provider will perform the work. A provider may be unwilling to perform a particular task for several reasons. For example, the provider may have an overbooked schedule or the provider may not have expertise in the particular area requested by the consumer (e.g., a window provider that handles commercial but not residential windows). If the provider is willing to perform the task, agreeing on terms can be a time consuming process of the provider reviewing the scope of work and providing the consumer a bid, followed by negotiation by the consumer to lower the price or to obtain multiple competitive bids to ensure a fair price.

Traditional methods of locating service providers are time consuming, involve many manual steps, and often involve consulting resources with out of date or inaccurate information. A consumer spends time and energy locating a service provider, only to find out that the service provider may be unwilling to perform the work. Finding a provider in a directory does not inform the consumer of whether the provider is currently available or willing to fulfill the consumer's request. In addition, communication is static and often one-way, where a provider updates directory information infrequently. A provider, for example, has no way to inform consumers of an opening in the provider's schedule, a new area of expertise, a particular available product, and so forth without expensive advertising that often does not reach the target consumer.

Recent online services, such as Angie's List, provide more advanced directories of provider information. For example, these directories often contain reviews of providers, example descriptions of the provider's work, and so forth. However, these services are still directories and have the limitations caused by one-way, delayed communication that are common to directories. Even upon finding a provider in an advanced online directory and viewing examples of past relationships with the provider, a consumer is still left contacting the provider, determining whether the provider is willing to perform the work, and negotiating with the provider or obtaining competitive bids.

### BRIEF DESCRIPTION OF THE DRAWINGS

FIG. 1 is a block diagram that illustrates components of the real-time sourcing system, in one embodiment.

FIG. 2 is a flow diagram that illustrates the processing of the system to automate a transaction between a consumer and provider, in one embodiment.

FIG. 3 is a flow diagram that illustrates the processing of the system to receive offers from providers in response to a request received from a consumer, in one embodiment.

FIG. 4 is a flow diagram that illustrates the processing of the system to setup a new provider with the system, in one embodiment.

### DETAILED DESCRIPTION

A real-time sourcing system is described herein that matches consumers with specific service requests to providers that perform the requested services. In addition, the system automates communication between consumers and providers. Unlike traditional systems for locating service providers, the real-time sourcing system provides automated and integrated end-to-end management of a transaction from the initial request to conclusion of the requested service. The system receives a request from a consumer that describes a particular service needed by the consumer. For example, the request may include one or more descriptive tags and criteria set by the consumer for the types of responses the consumer would like to receive. The system sends notifications to registered providers based on the requested service. For example, the system may notify providers subscribed to a category associated with the request. The system receives an offer from one or more notified providers that indicates terms under which the provider would perform the requested service. The system sends offers that match the consumer's criteria to the consumer for evaluation. The consumer and provider may send communications related to the offer. For example, the consumer may want to clarify the terms of the offer.

The system receives an acceptance of an offer from the consumer, and moves to a fulfillment stage. For example, the consumer may send a message to the system that indicates acceptance of a particular offer. The system receives an indication from the provider that the provider has rendered the services. For example, the provider may log onto a website provided by the system and mark the offer complete. In response, the system may confirm the completion with the consumer and provide payment to the provider. After the transaction concludes, the system allows the provider and consumer to submit feedback about each other. As noted herein, the system the servicing of service providers from end-to-end, providing the consumer with relevant and timely provider offers and memorializing terms of the transaction. Thus, the real-time sourcing system reduces the time involved with finding providers to perform services, and provides consumers with more relevant selections of providers to perform services.

Note that the system provides multiple ways in which consumers and providers can interact with the system to perform the steps described. For example, as described herein, many steps can be performed using text messages or by interaction with a website. In some transactions, a consumer and provider may carry out the entire process from initial request to agreement on terms of services in a very short period (e.g., several minutes). In addition, the consumer and/or provider may enter a transaction without logging on to a website associated with the system. For example, the system may allow an entire transaction to occur through text messages on the consumer and/or provider's cell phone. The system may also use Twitter, instant messaging (IM), interactive voice response (IVR), text-to-speech (TTS), and other modes of communication for exchanging messages and advancing the progress of a transaction managed by the system.

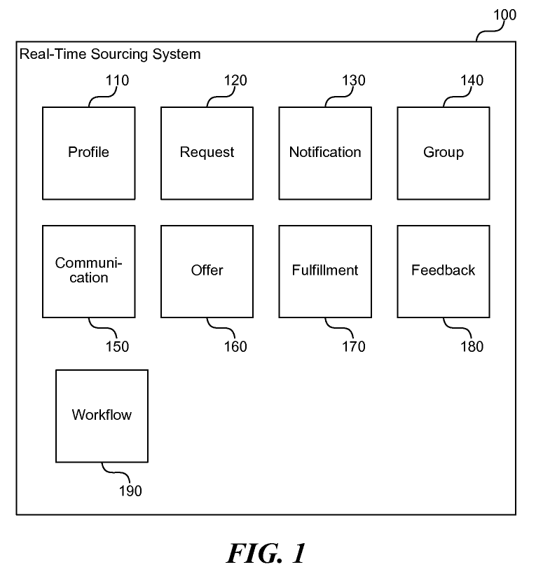

FIG. 1 is a block diagram that illustrates components of the real-time sourcing system, in one embodiment. The system 100 includes a profile component 110, a request component 120, a notification component 130, a group component 140, a communication component 150, an offer component 160, a fulfillment component 170, a feedback component 180, and a workflow component 190. Each of these components is described in further detail herein.

The profile component 110 manages user accounts for consumers and providers that register to use the system 100. When a user initially registers as a member of the system, the profile component 110 collects certain information from the user, such as an email address, demographic information, a default location (e.g., home address), a mobile number, and so forth. For example, the component 110 may collect references to other profiles of the user, such as a Twitter, Linkedln, Facebook, or other account with which the system may provide integration for communication, information gathering, and other actions. The profile component 110 may also track a subscription status that indicates whether the member has paid for access to certain upgraded services (e.g., increased priority of postings). In addition, the profile component 110 tracks a reputation score for each member and initializes the score during member registration. The system may provide a verification process to allow members to verify their identity and other profile information by supplying authentication information (e.g., a credit card, responding to a phone message, and so forth). The profile component 110 modifies the score later based on feedback that the component 110 receives from other members resulting from transactions with the member. A particular member may register as a consumer, provider, or both.

The request component 120 receives a posting from a consumer requesting one or more specific services that the consumer would like for a provider to perform. The request component 120 receives requests through a variety of communication channels, such as those described herein. For example, the component 120 may accept requests through Short Message Service (SMS) messages using a question and answer, wizard-like conversation. A received request may include information such as a title that describes the requested services, a more detailed description of the services or any particular preferences, a category associated with the request (e.g., plumbing, landscaping, and so forth), a location or geographic area of the member, tags associated with the request (e.g., plumbing, leak, emergency), and filtering information (e.g., a threshold reputation level of responding providers or group to which responding providers belong).

Depending on the communication channel through which the request component 120 receives the request, the component may provide a template that includes predefined request data, such as limiting the information described above to values that are most applicable to a particular type of request. For example, if the request is for landscaping services, then the component 120 may automatically filter out providers that are not in the same geographic area as the consumer. Categories and tags described above may provide a similar function of distinguishing requests from other requests and helping providers to find appropriate requests. While categories are often limited in number (e.g., a request may be limited to belonging to at most two categories), tags provide a more free form and searchable way of distinguishing requests that may cut across category boundaries. For some types of services, tags may allow finding requests across multiple categories that share a tag of interest to a particular provider.

Location as described herein may refer to various information that identifies a place at which the service will be performed. While an address may provide a precise indication of the service location, the system may provide more coarse-grained location information (e.g., zip code) to give the provider enough information to determine whether the request is in the provider's service area while still protecting the consumer's privacy before the consumer has entered into an agreement with a particular provider for the requested services.

In some embodiments, the request component 120 performs validation on received requests. For example, the request component 120 may ensure that the request does not include spam, that the text or other information associated with the request is reasonable for the selected category (and that the request is not incorrectly categorized), and so forth. If the component 120 finds errors in the request, the component 120 may bounce the request back to the consumer to make corrections. Validation allows the system 100 to maintain a higher quality of postings. The system may also offer a mechanism for other members to assist with validation, such as by flagging inappropriate posts.

The notification component 130 provides a notification to subscribers about new requests received from consumers. The notification component 130 may send notifications through a variety of configured channels, such as those described herein. For each subscriber, the profile component 110 may collect information that indicates how the provider would like to receive notification of new requests, and the type of requests for which the provider wants to receive notification. Providers may select one or more criteria that determine the types of requests that the notification component 130 will send to the provider. In addition, a provider may set filters that prevent the component 130 from sending the provider otherwise matching requests. For example, the provider may filter requests by consumer reputation and/or group enrollment. The system provides similar options for consumers to filter which providers the component 130 notifies, such as by specifying that a provider be bonded, have a particular amount of bond, hold specific licensing credentials/certifications, and so forth.

The group component 140 manages groups that providers may join. For example, a group may exist for registered contractors, plumbers, eco-friendly contractors, and so on. The system tracks a group administrator for each group that can determine the membership of the group (e.g., by accepting or denying requests to join the group) and set criteria for membership in the group. Some group administrators may have an official capacity, such as a state registrar of licensed contractors, while others may simply be a provider that created a group for a particular purpose relevant to that provider (e.g., contractors for sustainable building). Consumers may specify particular groups when submitting requests to narrow the search for an appropriate provider. In some embodiments, the system 100 provides a certification model that aggregates and presents information from other sources (e.g., case studies from a certifying organization or from consumers during the feedback phase described herein) to fortify the reputation of a member. Providers can present and showcase their independently obtained certifications and partnerships to other members through their profile.

The communication component 150 manages communications between consumers and providers. After a consumer submits a request and a provider receives notification about the request, the provider may have a question for the consumer to clarify the request. For example, the provider may want to know the consumer's timeframe for completing the request so that the provider can determine his/her availability to perform the requested services. The communication component 150 sends communications back and forth between the consumer and provider. The component 150 may allow the consumer (or provider) to indicate whether the system 100 will make a question and corresponding response visible and available to other providers. The communication component 150 may send communications over any of the channels already described, and members may select in their profile a preferred channel or priority among multiple channels for receiving communications. Thus, the provider may receive a notification via SMS and send a question via SMS, while the consumer may have sent the request via email and answer the question via a website provided by the system 100.

The offer component 160 manages financial or other terms of offers between providers and consumers. The offer component 150 may provide communications similar to the communication component 150; however, the communications provided by the offer component 150 differ in that they are usually in some sense binding on one party or include definite information about what a consumer or provider is willing to accept. For example, in response to a request notification, a provider may offer, through the offer component 160, to perform the requested services for a particular total amount or for a particular hourly rate. The system 100 may distinguish offers from other communications based on tags in the text of the communication (e.g., “offer:”) or by asking the provider in a wizard-like conversation (e.g., providers submits “I will do the work for $500,” the system replies “Is this a question or offer?” and the provider replies, “offer”).

In some embodiments, a provider informs the offer component 160 whether an offer is tentative or final. A tentative offer is one that is incomplete or contingent on additional information from the consumer. In response to a tentative offer, the offer component 160 may initiate a private conversation between the consumer and provider similar to the question/answer conversation described above, but not visible to other members. Alternatively or additionally, the provider may indicate that an offer is time-based or has other restrictions that the offer component 160 enforces. For example, if the provider has the afternoon open today but no time in the next few weeks, the provider may make the offer expire after the end of the day. If the consumer accepts the offer before it expires it is valid, otherwise the system 100 may no longer display the offer to the consumer or make any response to the offer non-binding on the provider without further provider confirmation.

In some embodiments, a provider may rescind an offer before the offer expires. For example, a provider's schedule may become full, the provider may discover in conversation with the consumer that the provider is not qualified to perform the requested services, and so forth. The provider can rescind the offer before the consumer has accepted the offer to prevent the consumer from accepting the offer.

When the consumer receives a satisfactory offer, the offer component 160 receives acceptance of the offer from the consumer. A consumer may receive multiple offers in response to a request, and select a particular offer to accept. The consumer may also reject other offers or simply leave the offers pending, so that if the first accepted offer falls through, the consumer can accept another offer. If the offer was tentative, the offer component 160 waits for the provider to accept the offer as well. If the offer was final, then the consumer's acceptance of the offer completes the offer stage and moves the request to the fulfillment stage described further herein.

The fulfillment component 170 manages a transaction after acceptance of an offer between the consumer and the provider. During the fulfillment stage, the provider renders the requested services and the consumer issues payment for the services based upon the agreed upon terms. In some embodiments, the consumer places the offer amount in escrow with the system 100 before the work begins. The system 100 may also offer insurance related to the transaction (e.g., insuring the provider's work and/or the consumer's payment). The provider indicates to the fulfillment component 170 when the services are complete. For example, the provider may log in to a website provided by the system 100 and submit a form indicating that the services are complete. The fulfillment component 170 may request confirmation from the consumer, and if the consumer agrees, the component 170 releases the payment to the provider. For example, the component 170 may transfer escrowed funds into an account associated with the provider.

In some embodiments, when the provider and consumer do not agree that the provider has completed the requested services in accordance with the terms of the offer, the system 100 provides a dispute resolution process. For example, the system may withhold payment and give the consumer and provider a certain period (e.g., 7 days) to resolve any issues with the work. The system 100 may allow the consumer to indicate when the work is finally complete or to indicate partial completion so that the system 100 will transfer partial payment to the provider. The system 100 may also allow the provider to issue refunds to the consumer as a concession for work with which the consumer is unsatisfied. In addition, a consumer may relist a request for offers that do not conclude in a successful transaction.

The feedback component 180 accepts feedback from the consumer and provider after a transaction is complete. After the fulfillment process (or earlier if the transaction does not reach fulfillment due to inability of the consumer and provider to agree on conclusion of the transaction), the system allows both the consumer and provider to submit feedback about each other. The submitted feedback affects a member reputation for each party maintained by the profile component 110. Consumers in future transactions can view the reputation of a provider and filter requests based on provider reputation. Likewise, providers can filter notifications based on consumer reputation and view the consumer reputation when considering requests. The feedback component 180 may accept feedback that includes a level indication (e.g., positive, negative, neutral), as well as ratings in response to specific questions (e.g., for quality of work, timeliness of services for the provider or payment for the consumer, and so forth). In some embodiments, each member gets one chance to respond to feedback left by the other member. This may allow, for example, a provider to explain the circumstances behind a transaction that did not conclude to the consumer's satisfaction.

In many existing systems, parties initially meet through an online service, but do not continue the transaction with the online service for various reasons. For example, the provider may contact the consumer by phone, negotiate a rate for services, and perform the services without informing the system. The feedback component 180 encourages members to complete transactions within the system 100 in order to increase their respective reputations. A provider has an incentive to build a high reputation based on consumer feedback. Similarly, a consumer has an incentive to build a high reputation based on provider feedback. Thus, even if the consumer and provider complete a transaction outside of the system 100, the feedback component 180 encourages them to inform the system of the outcome of the transaction.

The workflow component 190 provides a state machine that automatically manages a state of actions between consumers and providers and invokes the other components described herein to advance the state. For example, the workflow component 190 stores a list of outstanding requests received through the request component 120 and invokes the notification component 130 to notify providers. When a provider submits an offer, the workflow component 190 advances the state of the request to indicate that at least one offer has been received, and may close the request if the consumer does not want multiple offers. When the consumer accepts an offer, the workflow component 190 invokes the fulfillment component 170 to manage rendering of the requested services and payment. After the conclusion of the request, the workflow component 190 sends one or more reminders to the provider and consumer to submit feedback for each other.

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, surface computers, radio frequency ID devices, GIS-FPS related devices, projection devices, electronic book devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

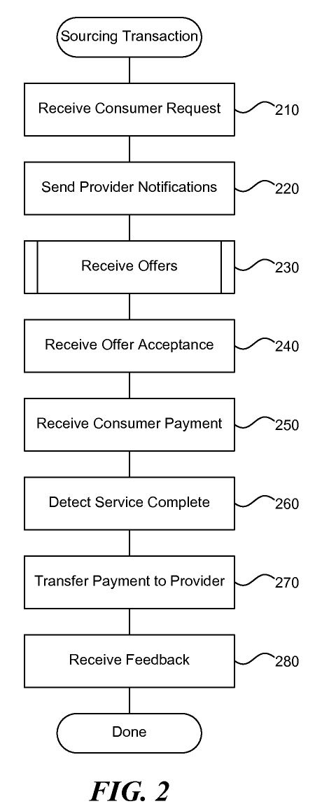

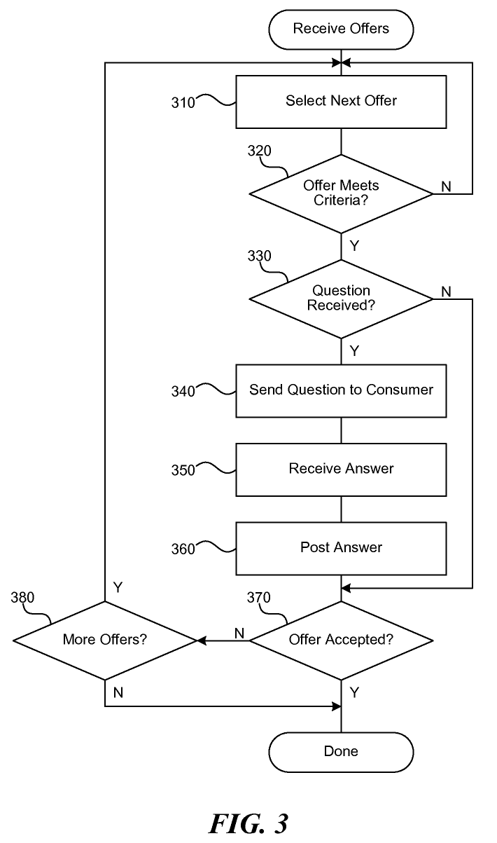

FIG. 2 is a flow diagram that illustrates the processing of the system to automate a transaction between a consumer and provider, in one embodiment. Beginning in block 210, the system receives a request from a consumer that specifies a service that the consumer wants performed. For example, the request may include information such as a title and description as well as distinguishing information, such as one or more categories and/or tags. Continuing in block 220, the system identifies providers matching the request and sends notifications to the identified providers to inform the providers of the request. For example, the system may identify providers associated with a category of the request and send each identified provider an email message including the request. Continuing in block 230, the system receives one or more offers from the notified providers, each offer including specified terms. For example, a provider may reply to a notification to make an offer to perform the service specified by the request. This process is described in further detail with reference to FIG. 3.

Continuing in block 240, the system receives acceptance of at least one offer from the consumer. For example, the consumer may reply to a provider's offer and indicate acceptance of the offer. Continuing in block 250, the system optionally receives payment from the consumer for the service in advance and holds the payment in escrow. For example, the consumer may provide the system with a credit card number to which the system can charge the transaction according to the specified terms of the accepted offer. Continuing in block 260, the system receives an indication from the provider that the service is complete. For example, after the provider finishes performing a requested service, the provider may log into a system website and mark an offer associated with the service completed. In some embodiments, the system confirms completion of the service with the consumer before continuing.

Continuing in block 270, the system transfers payment for the completed service from the consumer to the provider. If the system received advance payment, then the system transfers the payment from escrow to an account associated with the provider. Alternatively or additionally, the system may receive payment from the consumer after the service is completed and transfer the payment to the provider. In some embodiments, the provider and consumer may make payment arrangements outside of the system (e.g., cash in person) and inform the system that the payment is complete. Continuing in block 280, the system receives feedback for the consumer and provider. The system stores feedback to manage a reputation associated with each consumer and provider in the system. An individual member may be a consumer in some transactions and a provider in others. The system may maintain separate scores for the member's actions as a consumer and actions as a provider and/or may provide a combined score across all of the member's transactions. The system may provide the consumer and provider an option to respond to feedback received from the other party. After block 280, these steps conclude.

FIG. 3 is a flow diagram that illustrates the processing of the system to receive offers from providers in response to a request received from a consumer, in one embodiment. Beginning in block 310, the system receives and selects an offer from a provider. For example, the system may receive the offer via SMS or a website. The offer typically includes information describing the terms of the offer (e.g., an hourly rate or other charges). Continuing in decision block 320, if the offer satisfies criteria specified in the request, then the system continues at block 330, else the system loops to block 310 to select the next offer. A request may specify criteria, such as a threshold reputation of a provider to make an offer. If the offer or provider does not satisfy the criteria, then the system either may fail submission of the offer or may ignore the offer and not provide it to the consumer.

Continuing in decision block 330, if the provider submitted a question in response to the request, then the system continues at block 340, else the system jumps to block 370. For example, the provider may submit a question to clarify the service that the consumer is seeking. Continuing in block 340, the system sends the question to the consumer. For example, the system may send the consumer an SMS message, email message, or other form of communication that includes the question. Continuing in block 350, the system receives an answer to the question from the consumer and sends the answer to the provider. For example, the consumer may email a reply to the question from the consumer that the system forwards to the provider that submitted the question. Continuing in block 360, the system optionally posts the answer to the question so that it is visible to other providers in association with the request. For example, the consumer may indicate in the answer whether to post the answer for other providers if the question is likely to be asked by other providers.

Continuing in block 370, if the system received acceptance of the offer from the consumer, then the system completes, else the system continues at block 380. For example, the consumer may respond to an offer by indicating acceptance via email. Continuing in decision block 380, if there are more offers, then the system loops to block 310 to select the next received offer, else the system completes. The system may consider the next offer if the consumer explicitly rejected the current offer or simply did not respond to it. The system may allow the consumer to hold certain offers and respond to them later. When a consumer receives a satisfactory offer, then the consumer accepts the offer. Even after an offer is accepted, if the transaction does not complete, the consumer may return to other offers and accept a different offer. After block 380, these steps conclude.

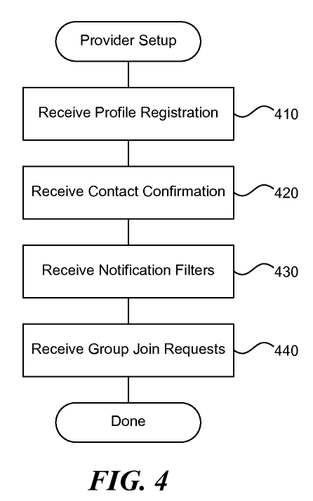

FIG. 4 is a flow diagram that illustrates the processing of the system to setup a new provider with the system, in one embodiment. Beginning in block 410, the system receives a profile registration from a new member of the system. The system may perform a similar profile registration for both consumers and producers. Members may act as a consumer in some transactions and as a producer in others. For example, a plumber may provide plumbing services to consumers as a provider but consume accounting services from other providers as a consumer. Continuing in block 420, the system confirms information specified by the new member in the profile registration. For example, the system may send a test email to a specified email address, an SMS message to a specified mobile phone, or other communication to confirm the validity of the specified information.

Continuing in block 430, the system receives one or more notification filters from the new member that specify the types of requests that the member is interested in receiving as a provider. For example, the member may specify particular categories or tags associated with requests in which the member has an interest, a threshold reputation of consumers from which the member receives offers, a geographic area of consumers that the member is willing to serve, and so forth. Continuing in block 440, the system optionally receives one or more requests from the new member to join one or more groups. For example, the new member may choose to join groups related to the member's particular trade, service philosophy, or organizations to which the member belongs. Group membership for closed groups may involve approval from a group administrator before the system admits the member to the group. Membership in a group may provide the member with additional request notifications and with access to information associated with the group.

After setting up the member's profile, the member begins receiving requests that match the member's notification filters. The member can then respond by making an offer or asking a question as described further herein. After block 440, these steps conclude.

In some embodiments, the real-time sourcing system includes advertisements in communications to consumers and providers. For example, when a consumer submits a request, the system may include an advertisement in the notification to providers about the request. The system may select the advertisement randomly or based on content within the request. For example, an advertiser may associate an advertisement with requests in a particular category or containing a particular keyword in the description. The system may also provide an advertisement in an offer from a provider to a consumer or other communications described herein. In addition, the system may provide a website through which members can interact with the system and modify configuration data, and the system may provide advertisements associated with request listings or other information displayed through the website. In some embodiments, the system uses the tags and categories described herein to syndicate requests submitted by members to external sites for advertising. For example, the system may associate a request having a particular tag with a Google Adwords advertisement having the tag as a keyword.

In some embodiments, the real-time sourcing system automatically creates templates for requests based on previously received requests. For example, the system may determine information commonly provided in requests for a particular category (e.g., plumbing) and ask for similar information in response to future requests in that category. In addition, the system can allow members or administrators to create templates for particular requests types. Templates reduce the information that a consumer enters to submit a request, and may improve the quality of requests by restricting request fields to predefined, valid values.

In some embodiments, the real-time sourcing system automatically filters requests based on geographic proximity of the consumer and provider. Consumers and providers provide geographic location information in their respective profiles when registering with the system. When a consumer makes a request, particularly for a category that involves the provider meeting the consumer at the consumer's location, then the system may not send a notification to providers beyond a predetermined distance from the consumer. The system may also allow the consumer to set the allowable distance of providers that receive notification about a request, either as a standing setting in the consumer's profile, or on a request-by-request basis.

In some embodiments, the real-time sourcing system restricts provider enrollment in groups. For example, the system may charge a fee for admission to a group and restrict providers from joining the group that have not paid the fee. As another example, a provider may have to belong to a group outside of the system to join a corresponding group managed by the system, such as a group of plumbers licensed to perform work in a particular state. Groups can be used to provide context and additional information about a provider, as well as providing a filtering criterion for consumers to limit notification of requests. A consumer may know that a particular group has a good reputation for a type of service that the consumer is requesting, and can limit notification of requests for that service by group.

In some embodiments, the real-time sourcing system maintains a group reputation for a group. The group reputation may be related to the individual reputations of the group members or a separate reputation based on consumer feedback about the group. The reputation of a group may make the group more desirable for providers to join and make the group more exclusive to increase the reputation for the group. Groups provide a way for consumers to learn about other providers based on an experience with another provider. For example, a consumer may have a successful transaction with a provider for a particular request, notice that the provider is part of a particular group with a high group reputation, and use other members of the group for future requests.

In some embodiments, the real-time sourcing system allows members of the system to follow other members within the system. Following a member adds the member to a list so that the requesting member can track information about the followed member. For example, a provider can watch clients' requests for services to make future offers in response to those requests. The system allows a provider to override filters by including followed consumers even when those consumers do not match filters set by the provider for notification of requests. Working for the same consumer in multiple transactions increases efficiency for the provider and builds a relationship between the consumer and provider. A provider may become familiar with the consumer's preferences as well as distinguished aspects of the consumer's environment (e.g., an older home, a particular variety of grass in the consumer's landscaping, and so forth) that allow the provider to suggest more relevant offers to the consumer's requests, which the provider can do by following the consumer within the system.

In some embodiments, the real-time sourcing system gathers statistics to provide to consumers, providers, and/or third parties. Data is often a valuable business resource, and the transactions managed by the system provide valuable insight into consumer and provider behavior and needs. Consumers may want to research a provider's acceptance rate (e.g., how often other consumers chose the provider) before accepting an offer. Likewise, providers may want to research the speed with which a provider pays bills, how often the consumer is dissatisfied with work performed, and so forth. Third parties may be interested in average cost of transactions for particular services. For example, a plumbing advertiser may be interested in the cost of an average transaction for fixing a leaky faucet. The system can track and provide these statistics. The system may provide a subscription model through which parties can subscribe to statistical data provided by the system for a periodic (e.g., annual) fee.

In some embodiments, the real-time sourcing system charges for various aspects of using the system. For example, the system may charge consumers to submit posts, charge providers to submit offers, charge a transaction fee on completed transactions, charge advertisers for providing advertisements on a system web site or in system communications, and so forth. The system may also charge members a periodic (e.g. monthly or annual) fee for using the system.

In some embodiments, the real-time sourcing system provides project management for larger projects that include more than one request. For example, a consumer building a home may submit requests for plumbers, electricians, framers, foundation experts, and so forth. The system may provide project management in the form of associating the offers so the consumer can view their status together, as well as other forms, such as scheduling of particular requests that are dependent on one another. For example, an electrician may not be able to perform work until a framer has completed framing a house. The system may provide reports, such as a Gantt chart for viewing project progress.

In some embodiments, the real-time sourcing system handles requests for non-monetary tasks. The system provides integrated communication and workflow management capabilities, and can be used for other purposes besides a money-based transaction. For example, charitable organizations may use the system to submit a request for volunteers for an event, real estate agents may submit notifications of real estate listings, a group administrator may post notifications to a group, and so forth.

From the foregoing, it will be appreciated that specific embodiments of the real-time sourcing system have been described herein for purposes of illustration, but that various modifications may be made without deviating from the spirit and scope of the invention. For example, although common contractor services have been used in examples herein, those of ordinary skill in the art will recognize that the system described can be employed in a variety of transaction types not limited to any particular field. Accordingly, the invention is not limited except as by the appended claims.

1. A computer-implemented method for automatically managing a transaction between a consumer and a provider, the method comprising:
receiving a request from the consumer that specifies a service that the consumer wants performed;
identifying one or more providers matching the request and sending a notification to the identified providers to inform the providers of the request;
receiving one or more offers from the notified providers, each offer including specified terms;
receiving acceptance of at least one offer from the consumer;
receiving an indication from the provider that the service is complete; and
receiving feedback for the consumer and provider,
wherein the preceding steps are performed by at least one processor.

2. The method of claim 1 wherein receiving a request from the consumer comprises receiving a request that includes one or more categories or tags associated with the request.

3. The method of claim 1 wherein identifying one or more providers comprises identifying providers associated with a category of the request.

4. The method of claim 1 wherein identifying one or more providers comprises identifying providers based on geographic distance to the consumer.

5. The method of claim 1 further comprising:
receiving payment from the consumer for the service in advance and holding the payment in escrow; and
transferring the received payment for the completed service from the consumer to the provider.

6. The method of claim 1 wherein sending a notification comprises including an advertisement with the notification.

7. The method of claim 1 wherein receiving one or more offers comprises receiving a reply via a communication channel of the notification.

8. The method of claim 5 wherein receiving payment in advance comprises receiving a payment from the consumer in accordance with the specified terms of the accepted offer.

9. The method of claim 1 wherein receiving an indication that the service is complete comprises confirming completion of the service with the consumer.

10. The method of claim 1 wherein receiving feedback comprises storing feedback to manage a reputation associated with each consumer and provider.

11. A computer system for matching consumers and providers to complete services, the system comprising:
a processor and memory configured to execute software instructions;
a profile component configured to manage user accounts for consumers and providers that register to use the system;
a request component configured to receive a posting from a consumer requesting one or more services that the consumer would like for a provider to perform;
a notification component configured to provide a notification to providers about new requests received from consumers;
a group component configured to manage groups that providers may join and consumers can specify when submitting requests to narrow the search for an appropriate provider;
a communication component configured to manage communications between consumers and providers;
an offer component configured to manage financial and other terms of offers between providers and consumers;
a fulfillment component configured to manage a transaction after acceptance of an offer between the consumer and the provider including accepting payments and determining whether services have been completed;
a feedback component configured to accept feedback from the consumer and provider after a transaction is complete; and
a workflow component configured to provide a state machine that automatically manages a state of actions between consumers and providers and invokes the other components to advance the state based on detected consumer and provider actions.

12. The system of claim 11 wherein the profile component is further configured to receive and store a geographic location associated with consumers and providers.

13. The system of claim 11 wherein the profile component is further configured to track a subscription status that indicates whether a member has paid for access to certain upgraded services.

14. The system of claim 11 wherein the profile component is further configured to track a reputation score for each consumer and provider, initialize the score during registration, and modify the score based on feedback received from other members resulting from transactions with a member.

15. The system of claim 11 wherein the request component is further configured to provide a template for filling in the posting based on a type of the posting.

16. The system of claim 11 wherein the request component is further configured to receive filtering information that determines providers eligible to respond to the request.

17. The system of claim 11 wherein the notification component is further configured to provide the notification based on one or more criteria specified by each provider that determine the types of requests that the provider receives.

18. A computer-readable storage medium comprising instructions for controlling a computer system to determine service requests to send to a provider, wherein the instructions, when executed, cause a processor to perform actions comprising:
receiving a profile registration from a new provider;
confirming contact information specified by the new provider in the profile registration;
receiving one or more notification filters from the new provider that specify one or more types of requests for which the provider is interested in receiving notifications;
receiving one or more requests from the new provider to join one or more groups; and
after setting up the provider's profile, sending requests that match the received notification filters to the new provider based on the received contact information and group membership.

19. The medium of claim 18 further comprising receiving a request from the provider to follow another registered member, wherein following the registered member comprises receiving requests from the member even if the requests do not satisfy the received notification filters.

20. The medium of claim 18 further comprising storing a group reputation associated with at least one group that the new provider requested to join.
